(19) United States
(12) Patent Application Publication
(10) Pub. No.: US 2026/0366678 A1
(43) Pub. Date: Nov. 19, 2026

(54) METHOD FOR THE OPERATION OF A TANK UNIT FOR STORING A GASEOUS FUEL AND TANK UNIT FOR STORING A GASEOUS FUEL

(71) Applicant: Robert Bosch GmbH, Stuttgart (DE)

(72) Inventors: Markus Strasser, Stuttgart (DE); Christian Kuhnert, Vaihingen/Enz (DE); Stefan Kieferle, Stuttgart (DE)

(21) Appl. No.: 19/148,356

(22) PCT Filed: Jan. 9, 2024
(86) PCT No.: PCT/EP2024/050385

§ 371 Date: Jul. 16, 2025

(30) Foreign Application Priority Data
Jan. 20, 2023 (DE) 10 2023 200 441.0

(51) Int. Cl. F17C 13/04; F17C 13/02

(52) U.S. Cl. CPC F17C 13/04; F17C 13/025; F17C 13/026; F17C 2205/0326; F17C 2221/012; F17C 2250/0439; F17C 2260/038; F17C 2265/065; F17C 2270/0165

(57) ABSTRACT

The present invention relates to a method for the operation of a tank unit (1) for storing a gaseous fuel with a tank unit (1), comprising one or more tank vessels (TB1, TB2, . . . , TBn) and at least one valve mechanism (2).

The invention also relates to a tank unit (1) for storing a gaseous fuel, comprising one or more tank vessels (TB1, TB2, . . . , TBn) and at least one valve mechanism (2).

### BACKGROUND

The present invention relates to a method for the operation of a tank unit for storing a gaseous fuel and a tank unit for storing a gaseous fuel.

In known accumulator tanks, safety devices and/or valves can be installed. Fuel cell systems having tank assemblies or tanks for gaseous media are known for this purpose. Accumulator tanks can be equipped with a valve in order to block or expel tank contents.

In conventional H2 tank systems with a plurality of gas tanks, each equipped with its own tank valve, not necessarily all tanks are equipped with their own pressure sensor. A determination of the tank level at the tank and for a plurality of tanks after reaching the pressure equalization is desirable.

DE112006003013B4 describes a tank with a fitting and a valve, wherein the valve is fastened in the fitting.

### SUMMARY

The present invention creates a method for the operation of a tank unit for storing a gaseous fuel and a tank unit for storing a gaseous fuel according to the disclosure.

The underlying concept of the present invention is to specify a method for operating a tank unit for storing a gaseous fuel and a tank unit for storing a gaseous fuel in which a leakage on a tank vessel can be better identified.

The invention relates to a method for the operation of a tank unit for storing a gaseous fuel, wherein the tank unit comprises one or more tank vessels and at least one valve mechanism, which connects the tank vessel to a gas conduit system, wherein the at least one valve mechanism is connected to a respective tank vessel, wherein the respective valve mechanisms are configured so as to admit and/or expel the gaseous fuel into or out of the respective tank vessel and/or to separate the tank contents of the respective tank vessel towards the gas conduit system; wherein the tank unit further comprises at least one high-pressure sensor in the gas conduit system, at least one temperature sensor in each tank vessel; and a control unit connected to the temperature sensors, the high-pressure sensor, and the valve mechanisms; the method comprising the steps of: determining and storing a gas temperature in each of the tank vessels via the temperature sensors and at least one pressure in the gas conduit system at a first time point prior to closing the valve mechanisms; determining a gas temperature in each of the tank vessels via the temperature sensors at a second time point prior to a secondary actuation of the valve mechanism; calculating an expected gas pressure in each of the tank vessels by means of the stored gas temperatures in the tank vessels and the pressure in the gas conduit system at the first time point and the gas temperatures in the tanks at the second time point; identifying the tank vessel having the least calculated expected gas pressure; actuating and opening the valve mechanism of the tank vessel with the smallest calculated expected gas pressure; determining the pressure that is settling into a steady state upon pressurization in the gas conduit system at a third time point; calculating the difference between the calculated expected gas pressure of the opened tank vessel and the pressure that is settling into a steady state after pressurization in the gas conduit system, corresponding approximately to the determination in the high-pressure and/or medium-pressure region; and comparing the difference to an allowable threshold, wherein, when this threshold is exceeded, a tank leakage is inferred.

During a downtime of a vehicle with a hydrogen storage system, it can be possible that different pressures settle in the individual tank vessels, which can result from different temperature changes in the individual tank vessels, for example because of different heating or cooling due to different tank designs or different environmental boundary conditions. The secondary actuation can correspond to an opening of a valve mechanism.

According to a preferred embodiment of the method, the calculated expected gas pressure in the gas conduit system is determined at the third time point as a function of the gas pressure of the tank vessel with the smallest calculated tank pressure and the pressure in the gas conduit system at the second time point.

According to a preferred embodiment of the method, the calculated expected gas pressure in the gas conduit system is determined at the third time point as a function of the pressure in the medium pressure gas conduit system at the second time point and the third time point.

According to a preferred embodiment of the method, the calculated expected gas pressure in the gas conduit system is determined at the third time point as a function of the consumed mass of gas of the consumer between the second time point and the third time point.

According to a preferred embodiment of the method, after opening of the valve mechanism on the tank vessel with the lowest pressure at the second time point, the temperature of the remaining tank vessels is monitored, thus making the identification of the tank vessel with the lowest pressure plausible.

According to a preferred embodiment of the method, the identification of the tank vessel with the lowest pressure is made plausible in that there is no increase in the temperature in the other tank vessels by more than a predetermined tolerance.

According to the invention, the tank unit for storing a gaseous fuel comprises one or more tank vessels, at least one valve mechanism, wherein the at least one valve mechanism is connected to a respective tank vessel, wherein the respective valve mechanisms are configured so as to admit and/or expel the gaseous fuel into or out of the respective tank vessel and/or separate the tank contents of the respective tank vessel towards the gas conduit system; a gas conduit system, which is connected to the at least one valve mechanism; at least one high-pressure sensor in the gas conduit system, at least one temperature sensor in each tank vessel; and a control unit connected to the temperature sensors, the high-pressure sensor, and the valve mechanisms and configured so as to carry out the method according to the invention.

The one or more tank vessels together with the gas conduit system can represent a gas storage system.

The gas conduit system can be used in order to supply the gaseous fuel to the tank vessels and also to remove the gas from the tank vessels towards the motor or fuel cell of the vehicle. The valve mechanism can comprise a closable valve, which can be electrically opened and closed. A pressure balance between the tanks can be brought about by opening the tank valves and delivering gas to the supply line to the gas conduit system.

The vehicle can be a fuel cell vehicle. The gaseous fuel can be a gaseous gas for the operation of a fuel cell, for example hydrogen or also other gases that are possible for this purpose. On the other hand, the gaseous fuel can also be a gas for a gas-powered vehicle, such as CNG or LPG, which can also be liquid gas.

The sensor unit can comprise one or more sensors that can detect a decrease in pressure and/or a pressure gradient and/or a temperature gradient and/or a temperature in the tank vessel or the gas conduit system.

The control unit can be connected to the valve mechanism of one or more tank vessels and sensors and can read them.

The method can also be characterized by the features mentioned in connection with the tank unit and by the advantages thereof, and vice versa.

Further features and advantages of embodiments of the invention are apparent from the following description with reference to the accompanying drawings.

### BRIEF DESCRIPTION OF THE DRAWINGS

The present invention is explained in greater detail below with reference to the exemplary embodiments indicated in the figures of the drawing.

Shown are:

FIG. 1 a schematic illustration of a tank unit for storing a gaseous fuel according to an exemplary embodiment of the present invention; and

FIG. 2 a block diagram of method steps of the method for operating a tank unit for storing a gaseous fuel for a vehicle according to an exemplary embodiment of the present invention.

### DETAILED DESCRIPTION

Identical reference signs in the figures denote identical or functionally identical elements.

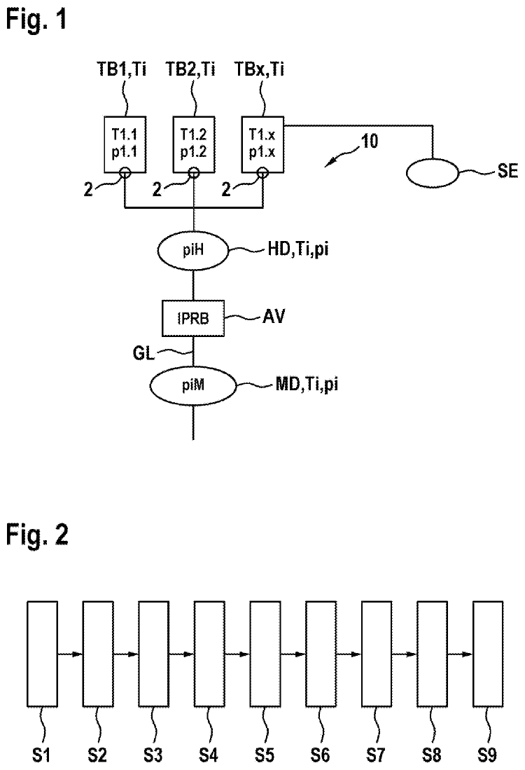

FIG. 1 shows a schematic illustration of a tank unit for storing a gaseous fuel according to an exemplary embodiment of the present invention.

The tank unit 1 for storing a gaseous fuel for a vehicle F comprises, according to FIG. 1, a plurality of tank vessels TB1, TB2, TBx, for example bottles that are or can be filled with hydrogen. The tank unit 1 comprises a plurality of valve mechanisms 2, wherein each of the tank vessels (TB1, TB2 . . . , TBx) is connected to its own valve mechanism 2, wherein the valve mechanism 2 is configured so as to admit and/or expel the gaseous fuel into or out of the at least one tank vessel; a gas conduit system GL, which is connected to the at least one valve mechanism 2; at least one high-pressure sensor piH in the gas conduit system GL, at least one temperature sensor Ti in each tank vessel; and a control unit SE, which is connected to the temperature sensors Ti and the high-pressure sensor piH, and is configured so as to read them, and wherein the control unit SE is connected to the valve mechanisms 2 (not shown for purposes of clarity) and is configured so as to close and/or open the valve mechanisms 2.

The gas conduit GL can comprise a high-pressure region HD and a medium-pressure region MD. The high-pressure region HD can connect to the valve mechanisms 2 of the tank vessels, and a release valve AV can be arranged between the high-pressure region and the middle-pressure region. In the high pressure region HD, there can be a temperature sensor Ti and a pressure sensor piH, for example a first pressure can be measured at a first time point. In the medium-pressure region MD, there can be a temperature sensor Ti and a pressure sensor piM.

Using the pressure in the high-pressure region at the first time point, the pressures in the tank vessels p1.1, p1.2, . . . p1.x at another time point can be inferred.

The first time point relates to a state of the vehicle in which the engine and/or the fuel cell is in operation and the valve mechanisms are open, but shutdown can be imminent. It can be assumed that the pressure in the high-pressure region HD of the gas conduit GL and the tank vessel is the same (or at least the same within a tolerance).

The valves can be closed when the vehicle is shut down. Prior to shutdown (first time point), the tanks and the gas conduit system can be pressure-balanced. The second time point can correspond to a time prior to a start of the vehicle and prior to an opening of the valves. Optionally, the calculation of the tank pressures can occur at the second time point, assuming that the conduit system (also the high-pressure and medium-pressure system) and the tank vessels (when, for example, an ambient temperature corresponds to all tank temperatures) are temperature-balanced.

The resulting pressure at the third time point (after opening the valve) can be measured at the high-pressure and medium-pressure regions.

The method can be used in order to monitor a tank for tightness. Furthermore, at the first time point, the pressure in the medium-pressure region can also be measured. At the second time point, in particular prior to the re-start of the vehicle and/or the fuel cell, and with the valve mechanisms on the tank vessels still closed, the temperatures and the pressure can be measured at the high pressure region and the medium-pressure region. Changes in the temperature during downtime can cause the pressures in the tank vessels to vary, including, for example, if there is a leak. For example, the pressure at the second time point and at the nth tank vessel can be calculated according to p2.x=p1.x*(T2.x/T1.x), wherein the index 1 represents the variable at the first time point and the index 2 represents the variable at the second time point. At the third time point, i.e. after opening the valve on the tank vessel with the lowest pressure, the required mass in the high-pressure and medium-pressure region for the pressurization in MD and HD and, if applicable, the mass at the consumer can be determined, and it can be advantageously identified whether p3MD>p2MD, p3HD>p2HD as the pressure at the third time point in the medium-pressure region can be greater than the pressure at the second time point in the medium-pressure region, likewise for the high-pressure region.

If necessary, the mass of the gaseous fuel already used by the consumer (determined for example from a flow rate over time) can be taken into account.

FIG. 2 shows a block diagram of method steps of the method for operating a tank unit for storing a gaseous fuel for a vehicle according to an exemplary embodiment of the present invention.

According to the invention, in the method for operating a tank unit for storing a gaseous fuel, the following occurs: determining S1 and storing S2 a gas temperature in each of the tank vessels via the temperature sensors and at least one pressure in the gas conduit system at a first time point prior to closing the valve mechanisms; determining S3 a gas temperature in each of the tank vessels via the temperature sensors at a second time point prior to a secondary actuation of the valve mechanism; calculating S4 an expected gas pressure in each of the tank vessels by means of the stored gas temperatures in the tank vessels and the pressure in the gas conduit system at the first time point and the gas temperatures in the tanks at the second time point; identifying S5 the tank vessel having the least calculated expected gas pressure; actuating and opening S6 the valve mechanism of the tank vessel with the smallest calculated expected gas pressure; determining S7 the pressure that is settling into a steady state upon pressurization in the gas conduit system at a third time point; calculating S8 the difference between the calculated expected gas pressure of the opened tank vessel and the pressure that is settling into a steady state after pressurization in the gas conduit system; comparing S9 the difference to an allowable threshold, wherein, when this threshold is exceeded, a tank leakage is inferred.

Although the present invention has been described in full with reference to the preferred embodiment, it is not limited thereto and can be modified in many ways.

1. A method for the operation of a tank unit (1) for storing a gaseous fuel, wherein the tank unit (1) comprises:
one or more tank vessels (TB1, TB2, . . . , TBn),
at least one valve mechanism (2), which connects the tank vessel (TB1, TB2; . . . TBn) to a gas conduit system (GL), wherein the at least one valve mechanism (2) is connected to a respective tank vessel (TB1, TB2 . . . , TBn), wherein the respective valve mechanisms (2) are configured so as to admit and/or expel the gaseous fuel into or out of the respective tank vessel (TB1, TB2 . . . , TBn) and/or to separate the tank contents of the respective tank vessel (TB1, TB2 . . . , TBn) towards the gas conduit system; at least one high-pressure sensor (piH) in the gas conduit system (GL),
at least one temperature sensor (Ti) in each tank vessel; and
a control unit (SE) connected to the temperature sensors (Ti), the high-pressure sensor (piH), and the valve mechanisms (2);
the method comprising the steps of:
determining (S1) and storing (S2) a gas temperature in each of the tank vessels via the temperature sensors and at least one pressure in the gas conduit system at a first time point (t1) prior to closing the valve mechanisms (2);
determining (S3) a gas temperature in each of the tank vessels via the temperature sensors at a second time point (t2) prior to a secondary actuation of the valve mechanism (2);
calculating (S4) an expected gas pressure in each of the tank vessels by means of the stored gas temperatures in the tank vessels and the pressure in the gas conduit system at the first time point (t1) and the gas temperatures in the tanks at the second time point (t2);
identifying (S5) the tank vessel having the least calculated expected gas pressure;
actuating and opening (S6) the valve mechanism of the tank vessel with the smallest calculated expected gas pressure;
determining (S7) the pressure that is settling into a steady state upon pressurization in the gas conduit system at a third time point (t3);
calculating (S8) the difference between the calculated expected gas pressure of the opened tank vessel and the pressure that is settling into a steady state after pressurization in the gas conduit system (GL);
comparing (S9) the difference to an allowable threshold, wherein, when this threshold is exceeded, a tank leakage is inferred.

2. The method according to claim 1, wherein the calculated expected gas pressure in the gas conduit system is determined at the third time point (t3) as a function of the gas pressure of the tank vessel with the smallest calculated tank pressure and the pressure in the gas conduit system at the time point (t2).

3. The method according to claim 1, in which the calculated expected gas pressure in the gas conduit system is determined at the third time point (t3) as a function of the pressure in the medium pressure gas conduit system at the second time point (t2) and third time point (t3).

4. The method according to claim 1, in which the calculated expected gas pressure in the gas conduit system is determined at the third time point (t3) as a function of the consumed gas mass of the consumer between the second time point (t2) and the third time point (t3).

5. The method according to claim 1, in which, after opening of the valve mechanism on the tank vessel with the lowest pressure at the second time point (t2), the temperature of the remaining tank vessels is monitored, thus making the identification of the tank vessel with the lowest pressure plausible.

6. The method according to claim 5, in which the identification of the tank vessel with the lowest pressure is made plausible by ensuring that no temperature increase in the other tank vessels occurs by more than a predetermined tolerance.

7. A tank unit (1) for storing a gaseous fuel, comprising:
one or more tank vessels (TB1, TB2, . . . , TBn),
at least one valve mechanism (2), wherein the at least one valve mechanism (2) is connected to a respective tank vessel (TB1, TB2, . . . , TBn), wherein the respective valve mechanism (2) is configured so as to admit and/or expel the gaseous fuel into or out of the respective tank vessel (TB1, TB2, . . . , TBn) and/or to separate the tank contents of the respective tank vessel (TB1, TB2, . . . , TBn) towards the gas conduit system;
a gas conduit system (GL) connected to the at least one valve mechanism (2);
at least one high-pressure sensor (piH) in the gas conduit system (GL),
at least one temperature sensor (Ti) in each tank vessel; and
a control unit (SE) connected to the temperature sensors (Ti), the high-pressure sensor (piH), and the valve mechanisms (2) and configured so as to
determine (S1) and store (S2) a gas temperature in each of the tank vessels via the temperature sensors and at least one pressure in the gas conduit system at a first time point (t1) prior to closing the valve mechanisms (2);
determine (S3) a gas temperature in each of the tank vessels via the temperature sensors at a second time point (t2) prior to a secondary actuation of the valve mechanism (2);
calculate (S4) an expected gas pressure in each of the tank vessels by means of the stored gas temperatures in the tank vessels and the pressure in the gas conduit system at the first time point (t1) and the gas temperatures in the tanks at the second time point (t2);
identify (S5) the tank vessel having the least calculated expected gas pressure;
actuate (S6) the valve mechanism of the tank vessel with the smallest calculated expected gas pressure;
determin (S7) the pressure that is settling into a steady state upon pressurization in the gas conduit system at a third time point (t3);
calculate (S8) the difference between the calculated expected gas pressure of the opened tank vessel and the pressure that is settling into a steady state after pressurization in the gas conduit system (GL);
compare (S9) the difference to an allowable threshold, and
when this threshold is exceeded, infer a tank leakage.
